(19) United States
(12) Patent Application Publication
(10) Pub. No.: US 2004/0093311 A1
(43) Pub. Date: May 13, 2004

(54) Device, system, and method for administering shipping charges in a shopping chart

(76) Inventors: Michael Chew, San Jose, CA (US); Jianpeng Shi, San Jose, CA (US); Niraj Kanthi, Sunnyvale, CA (US); James Morales, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/294,243

(22) Filed: Nov. 13, 2002

(51) Int. Cl. G06F 17/60; G06F 17/00

(52) U.S. Cl. 705/401; 705/409

(57) ABSTRACT

A method of creating and maintaining a shipping-charge database is provided. The method includes the steps of receiving a shipping-charge data set into a shipping-charge administration tool from the administrator client, the data set including a plurality of possible order price ranges, at least one shipping option for each price range, and a shipping charge for each shipping option, and causing the shipping-charge data set to be stored at a location exposed to a server for use in establishing a shipping charge for an on-line order in response to a price of the order and a shipping-option selection for the order. The method is extendable and may be used to create and maintain other databases, such as airline and hotel pricing databases.

### BACKGROUND

Generally, when one orders a product or an item over the Internet, by telephone, or by any other means, shipping and handling charges are added to the order. Typically, the shipping and handling charges are associated with the product. So for example, if one buys a printer, then there is a specific shipping and handling charge associated with that particular printer. If one buys a number of items, then the seller adds up the shipping and handling charges specified for all of the individual products to arrive at a total shipping and handling charge. The charge may be based on the individual product's value, category, weight, or bulk. Furthermore, the shipping and handling charge for a product usually depends on the shipping and handling options selected by the customer. Examples of shipping options include five-to-seven business days, two business days, overnight, priority overnight, and Saturday delivery.

For purchases made over the Internet, it is typically desired to compute the total cost including the shipping and handling charges automatically, preferably using a computer such as the server that hosts the website. To compute the shipping and handling charge, the server needs access to the different shipping and handling charges for each item or category of the item for each of the different shipping options discussed above. Unfortunately, programming and updating shipping and handling information for individual items or classes of items into a database, such as that used by many web-based shopping sites, typically requires a highly trained person who is familiar with the database, able to enter the charges so there are no overlapping ranges or mistakes in setting up the options, and able to address firewall issues to access the server to enter the charges. Furthermore, while a database is being updated, the server is typically off-line, and thus people cannot make purchases during this time. Additionally, business decisions may result in frequent changes to the shipping charges, thus creating significant overhead in establishing and maintaining a shipping and handling charge structure based upon individual items or classes of items.

Furthermore, it is sometimes desirable to have different kinds of promotions that modify the shipping and handling charges. For example, a business can have a promotion where if the total order is over a certain amount of money, the shipping is free, or has a low flat rate. Alternatively, one can have a promotion where a free upgrade to a more desirable, usually faster shipping alternative, is available. The promotion may be for all shipping options, or only when the order is over a certain amount of money. Again, entering this information into the database is typically time consuming and requires a skilled person who is familiar with the database. It also may require that the shopping site be taken off line for a period of time while these updates are entered manually.

### SUMMARY

In view of the foregoing, there is a need for a new and improved apparatus, system, and method for establishing and modifying shipping and handling charges, for updating those charges, and for establishing promotional schemes that temporarily modify the shipping and handling charges. For example, there is a need to set the total shipping and handling charges based on the total amount of money that the consumer spends. So, for example, if the consumer spends a total of $100 (regardless of how many products are purchased) then the seller may wish to set the shipping and handling price at an amount A. If the customer spends between $100 and $200, then the shipping and handling charges may be B. This allows the seller to typically give a price reduction to the consumer on the shipping and handling charges when the consumer makes a larger purchase.

In one embodiment of the invention, a method of generating a shipping-charge database is provided. The method includes the steps of providing a communications link between a server and a browser enabled administrator client, and providing an administrator client with a browser-based interface for accessing a shipping-charge administration tool. The method also includes receiving into the shipping-charge administration tool from the administrator client a shipping-charge data set, the data set including a plurality of possible order price ranges, at least one shipping option for each price range, and a shipping charge for each shipping option for each price range. The method further includes causing the shipping-charge data set to be stored at a location exposed to the server for use in establishing a shipping charge for an on-line order in response to a price of the order and a shipping-option selection.

Such a method allows an administrative user to establish and modify shipping charges for orders placed on a web server that has access to the database, and to update those charges without taking the server off-line.

These and various other features as well as advantages of the present invention will be apparent from a reading of the following detailed description and a review of the associated drawings.

### BRIEF DESCRIPTION OF THE DRAWINGS

The features of the present invention which are believed to be novel are set forth with particularity in the appended claims. The invention, together with further objects and advantages thereof, may best be understood by making reference to the following description taken in conjunction with the accompanying drawings, in the several figures of which like referenced numerals identify like elements, and wherein:

FIG. 1 is a block diagram illustrating a server 210, an administrator client 250, and a client 220, according to an embodiment of the present invention;

FIG. 2 is a screen print of a web-based interface 300 provided by a shipping administrator tool 212 to the administrator client 250 for creation of a shipping-charge data set, according to with an embodiment of the invention;

FIG. 3 is a screen print of a web-based interface 400 for creation of a promotional-shipping-charge data set provided by the shipping administrator tool 212 to the administrator client 250, according to an embodiment of the invention; and

FIG. 4 is a screen print of a web-based page 500 provided by the tool 212 showing the current shipping-charge data set stored in the production-shipping-charge database of the shipping-rates database 214, according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

Additionally, throughout the specification, claims, and drawings, the term “shipping charge” includes all charges that might be added to an order, particularly an Internet shopping cart, based upon the order, including those customarily described as shipping, handling, insurance, special handling, duties, rush service, and freight. While “shipping charge” may be generally associated with a charge or expense incurred in getting the items of the order to the customer, as used in these specifications “shipping charge” may also include any other charges added to an order based upon the value of the order.

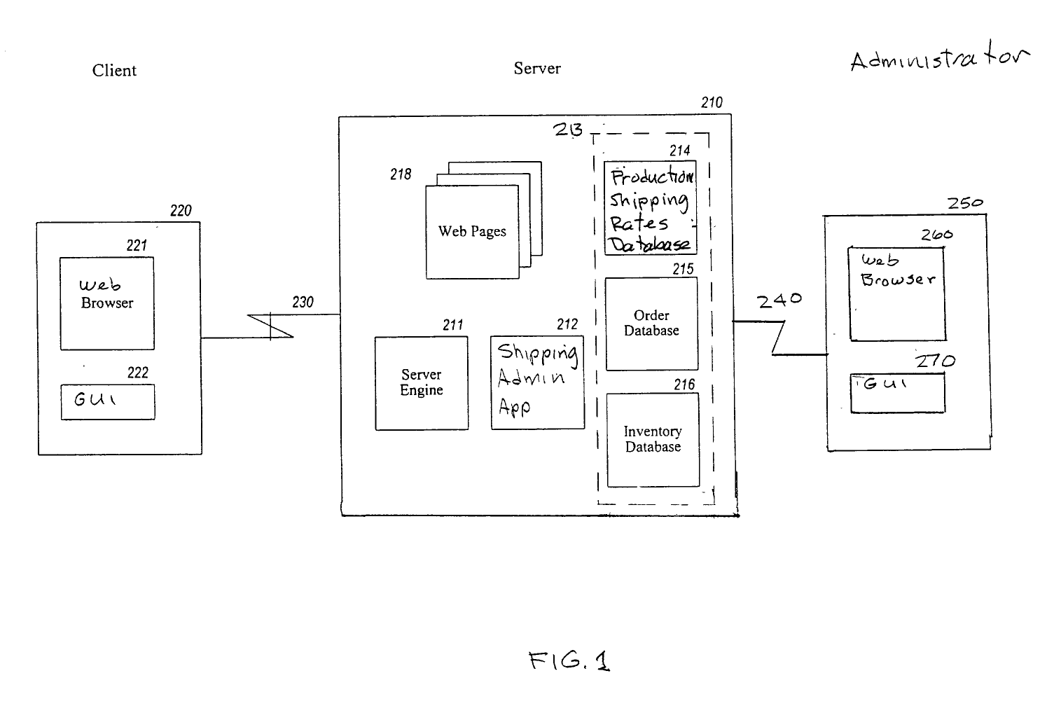

FIG. 1 is a block diagram illustrating a server 210, an administrator client 250, and customer client 220, according to an embodiment of the present invention. This embodiment supports ordering products over the Internet using the World Wide Web. The server 210 includes a server engine 211, a shipping administrator application 212, storage 213 that includes a production-shipping-rates database 214, an order database 215, and an inventory database 216, and various Web pages 218. The server engine 211 receives HTTP requests to access Web pages identified by URLs and provides the Web pages to the various client systems. The production-shipping-rates database 214 includes a shipping-charge data set for a plurality of non-overlapping, possible order price ranges, at least one shipping option for each price range, and a shipping charge for each shipping option for each price range. The database 214 may also include a promotional-shipping-charge data set that includes at least one promotion for a shipping option that provides a customer with free shipping or a free upgrade to a more preferred shipping option during a portion of time.

The order database 215 includes an entry for each order that has not yet been shipped to a purchaser. The inventory database 216 includes a description of the various products that may be ordered by a purchaser. In addition, the server system 210 may include any combination of hardware or software that can generate orders.

The customer-client system 220 includes a web browser 221, a graphical user interface (GUI) 222, and associated devices that allow the client system to communicate with the server 210. The server and customer-client system interact by exchanging information via communications link 230, which may include transmission over the Internet. Various communication links may be used, such as local-area network, wide-area network, or point-to-point dial-up connection. The customer-client system 220 may include any combination of hardware or software that allows the customer-client system 220 to interact with the server 210.

The administrator client 250 includes a web browser 260, a graphical user interface (GUI) 270, and associated devices allowing the administrator client 250 to communicate with the server 210. The administrator client 250 and the server 210 interact by exchanging information via a communications line 240, which may include transmission over an intranet within the enterprise associated with the server 210, or over the Internet.

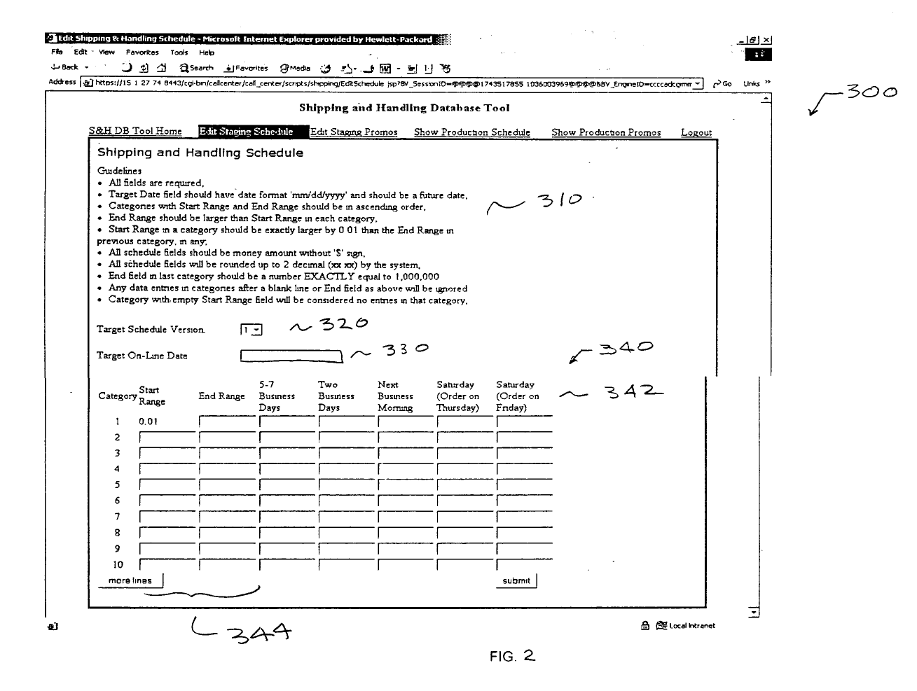

FIG. 2 is a screen print of a web-based interface 300 provided by the shipping administrator tool 212 to the administrator client 250 (FIG. 1) for creation of a shipping-charge data set, according to an embodiment of the invention. The web-based interface 300 includes guidelines 310, a version dialog box 320, a target on-line date dialog box (start time) 330, and a matrix 340 for creation of the shipping-charge data set, which includes a row for creating shipping options 342 and a pair of columns for creating a plurality of price ranges 344.

The shipping administrator tool 212 (called “Shipping and Handling Database Tool” in several figures) is a software application that allows administrative personnel to enter, maintain, and schedule the updates to the shipping-charge data set and the promotional-shipping-charge data set. These data sets will be stored in the production-shipping-rates database 214 (FIG. 1) by the tool 212 when their respective target on-line dates are in effect. The production-shipping-charge data set and the production-promotion-shipping-charge data set are used by the server 210 for establishing a shipping charge for an order placed by a customer using customer client 220. Once the customer completes selection of items in their shopping cart, the prices of all the products are totaled to determine a price of the order. The customer provides the server 210 with a shipping-option selection. The server 210 accesses the production-shipping-rates database 214 and establishes a shipping charge for the order in response to the shipping-option selection and the price of the order

The tool 212 also provides an environment for interim storage of the shipping-charge data sets and promotional-shipping-charge data sets in a memory or storage other than the production-shipping-rates database 214. The interim stored data sets are sometimes referred to in these specifications as staged sets. The tool 212 at its instigation sends or pushes the staged sets from their interim or staging storage into the production-shipping-rates database 214 on their target on-line date. The functionality of the tool 212 to push a staged set into the database 214 when its target on-line date is reached allows the tool 212 to manage the database 214. This relieves the server-operating system from having to poll whether a target on-line date has been reached for a new data set, and to then pull that data set into the database 214. The tool 212 does not control the way these data sets are consumed by applications on the server 210 or any other affiliated application. In one embodiment, the tool 212 resides on the server 210, which may be the same location where the web pages 218 are stored, and typically will receive service from the same physical data storage 213 used by the web pages 218 and applications supporting ordering with the server 210.

The tool 212 presents administrative personnel with a series of web-based user interfaces to create and maintain a shipping-charge data set. First, the user receives a log-on page where the user enters the user's ID and a password, and clicks on “login” button. Then, the tool 212 verifies the credentials and user authorization, and allows the access to the tool's home page. At the tool's home page, the user can select from relevant tabs to perform the desired operations:

“Edit staging schedule” option allows the user to enter information to create a new shipping-charge data set or to edit an existing shipping-charge data set that has not been pushed into the production-shipping-rates database 214.

“Edit staging promos” option allows the user to enter information related to a new promotional-shipping-charge data set or edit an existing, staged promotional-shipping-charge data set that has not been pushed into the production-shipping-rates database 214.

“Show production schedule” and “show production promos” options display the current production-shipping-charge data set and promotional-shipping-charge data set respectively that are stored the production-shipping-rates database 214.

“Logout” option exits the user from the tool.

When the “edit staging schedule” is clicked on in the home page, the user is presented with the a web-based interface 300 for creation of a shipping-charge data set provided by the shipping administrator tool 212 as illustrated in FIG. 2. The interface 300 may be configured in any manner suitable for entering a shipping-charge data set. In an embodiment illustrated in FIG. 2, the interface 300 includes guidelines 310 to aid administrative personnel in entering the shipping-charge data set. The target schedule version dialog box 320 may be arranged to automatically select the next number in a sequence, or allow the user to input a version. The target on-line date dialog box 330 is for entry of a start time when the shipping-charge data set will become effective for establishing a shipping charge for an order, and may be arranged to only allow entry of dates in a format described in the guidelines 310.

The matrix 340 for creation of the shipping-charge data set may be structured in any arrangement suitable for entry of a shipping-charge data set compatible with the operation of the server 210. In web-based interface 300, the user can either enter a new shipping-charge data set (shopping cart ranges and shipping charge for each shipping option) or edit a previously entered staging shipping-charge data set. A staging shipping-charge data set is a data set that has not gone into effect and become a production data set. The tool 212 allows for a plurality of shipping options 342, which may be arranged in a row or column. The tool 212 also allows for a plurality of price ranges 344, which may be arranged to visually intersect with the shipping options. The embodiment illustrated in FIG. 2 provides for five shipping options 342 in order of diminishing shipping time traversing to the right on a row, and ten price ranges 344 in order of increasing price moving down a pair of columns. By default, the embodiment of the tool 212 illustrated provides ten price ranges, but if the user wants more ranges, clicking the “more lines” button adds five lines each time. The user enters into the web-based interface 300 a shipping charge for each shipping option for each price range having a shipping option. The web-based interface 300 may also provide for the user to enter text containing shipping information guidelines or other information for display to a customer.

Table 1 below illustrates a shipping-charge data set created with the tool 212. The data set has nine non-overlapping, contiguous price ranges and five shipping options, with a shipping charge for each price range. The ranges are contiguous in that every possible price lies within the plurality of possible order price ranges. In a further embodiment, non-contiguous shipping ranges may be selected when the possible price ranges do not include certain prices. For example, if the products on a web-site were always in multiples of five dollars, the first range could be less than $75, and the second range could be $80-$150. Although a shipping cost is shown for each shipping option of each price range, the shipping cost may be zero.

TABLE 1

| | | | Next | Saturday | Saturday |
|---|---|---|---|---|---|
| | 5-7 Business | Two Business | Business | (Order On | (Order on |
| Your Merchandise Total | Days | Days | Morning | Thursday) | Friday) |
| less than $75.00 | $4.99 | $9.99 | $14.99 | $14.99 | $19.99 |
| $75.01-$150.00 | $7.99 | $12.99 | $17.99 | $17.99 | $22.99 |
| $150.01-$250.00 | $9.99 | $14.99 | $19.99 | $19.99 | $24.99 |
| $250.01-$500.00 | $10.99 | $19.99 | $24.99 | $24.99 | $29.99 |
| $500.01-$1,000.00 | $20.99 | $39.99 | $49.99 | $44.99 | $59.99 |
| $1,000.01-$1,500.00 | $30.99 | $59.99 | $69.99 | $64.99 | $79.99 |
| $1,500.01-$2,500.00 | $40.99 | $69.99 | $79.99 | $74.99 | $89.99 |
| $2,500.01-$4,000.00 | $50.99 | $79.99 | $89.99 | $84.99 | $99.99 |
| more than $4,000.01 | $60.99 | $89.99 | $99.99 | $94.99 | $109.99 |

When the “submit” button of the web-based interface 300 is selected, the tool 212 receives the shipping-charge data set created in web-based interface 300 by a user of the administrator client 250. The tool 212 verifies the shipping-charge data set by checking for errors such as missing ranges, overlapping ranges, non-numeric values, valid “target on-line date,” etc. When all the data elements are correct, the tool 212 presents a confirmation page to the user. Otherwise, an error message is provided the user, who has the opportunity to the correct the error. At the start time entered in the target on-line date dialog box 330, the tool 212 causes the shipping-charge data set to be stored in the shipping-rates database 214, which is a location exposed or available to the server 210 for establishing a shipping charge for an order in response to a price of an order and a shipping-option selection. That is, the shipping-charge data set goes into effect at the entered start date by being stored in the shipping-rates database 214 where it is accessed by the server 210 for establishing shipping charges.

A further embodiment of the invention allows a user to create and stage a plurality of shipping-charge data sets using the web-based interface 300, each of which has a unique start time when it goes into effect for establishing a shipping charge. For example, assume the shipping-charge data set displayed in Table 1 is designated as target schedule version 1 in version dialog box 320, and is the current production-shipping-rate data set stored in shipping rates database 214. The tool 212 allows another shipping-charge data set to be received, which could be designated as target schedule version 2. The tool 212 would verify it as described above, and then store the version 2 shipping-charge data set, preferably in a location assigned for staging shipping-charge data sets. Each night just after midnight (when system clock changes the system date), a batch job runs. This job first checks whether the version 2 shipping-charge data set is due to move from staging to the production-shipping-rates database 214. When the “target on-line date” in the start time of the version 2 shipping-charge data set equals system date, the tool 212 archives the existing production-shipping-charge data set (version 1) and pushes the version 2 shipping-charge data set into the production-shipping-rates database 214, where it is available for production. The archive may be a shipping-charge history database. A plurality of shipping-charge data sets may be created. As business decisions require other shipping-charge data sets to be created, the tool 212 can be used to create, verify, stage, and push those data sets into the production-shipping-rates database 214. By way of further example, the tool 212 will allow a target schedule version 3 to be created having a target on-line date, or start time, lying between the start times of versions 1 and 2, or subsequent to version 2.

Another embodiment of the invention provides for a shipping-charge data set to be selected by a user from a library of possible shipping-charge data sets, and the selected data set is received into the shipping-charge administration tool 212 in a manner similar to a shipping-charge data set created using the web-based interface 300. The library may be from any source, such as archived, previously used shipping-charge data sets, or provided by a third party.

Referring again to FIG. 1, the administrator client 250 may be a terminal coupled to the server 210, or may be a separate computing device communicating with the server 210 via a network. In one embodiment, the administrator client 250 is a separate computing device communicating with the server 210 over a secure intranet. This allows administrative personnel to perform administration without being physically in the same location as the server 210.

In a still further embodiment, the shipping tool 212 allows certain products, such as a warranty, to be flagged as ship-exempt products not used in calculating the price of an order for establishing a shipping charge. The invention may also provide that other products are flagged for extra-shipping charges, such as heavy products.

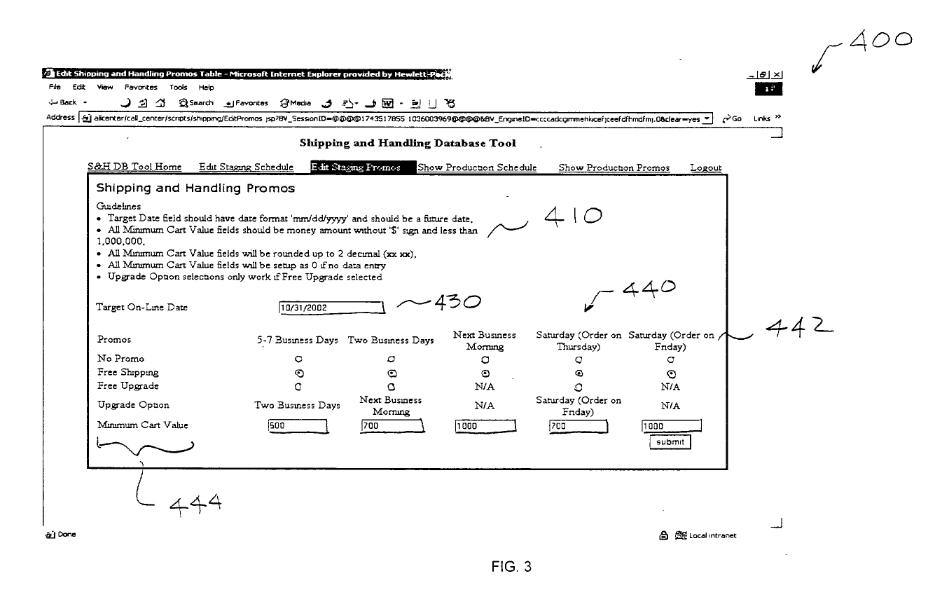

FIG. 3 is a screen print of a web-based interface 400 for creation of a promotional-shipping-charge data set provided by the shipping administrator tool 212 to the administrator client 250 (FIG. 1), according to an embodiment of the invention. The web-based interface 400 includes guidelines 410, a target on-line date dialog box (start time) 430, and a matrix 440 for creation of the promotional-shipping-charge data set that includes columns of shipping options 442 and rows of price ranges 444 within which the corresponding promotion applies. While FIG. 3 shows certain selections and entries having been made, the web-based interface 400 provided by the shipping administrator tool 212 to the administrator client 250 typically would not contain pre-entered selections and entries.

The shipping administrator tool 212 presents a user with an “Edit staging promos” option. This option allows the user to enter information related to a new promotional-shipping-charge data set or to edit a staged promotional-shipping-charge data set that has not been pushed into the production-shipping-rates database 214. This embodiment of the tool 212 supports two types of shipping promotions:

1. Free shipping—No shipping charge for specific shipping method if the shopping-cart value exceeds “minimum-cart value.”

2. Free upgrade—If the shopping-cart value exceeds “minimum-cart value,” a customer will be charged for given shipping option, even when the customer selects “upgrade option, and the order will be shipped using a higher priced shipping option.

The “free shipping” and “free upgrade” promotions can be turned on or off for each shipping option, and a minimum shopping-cart value can be established for application of the promotion for each shipping option. Only a single promotion can be specified for a shipping option. The promotional-shipping-charge data set will apply to the production-shipping-charge data set stored in the shipping-rates database 214 at the target on-line date (or start time). The target on-line date dialog box 430 may also include a target off-line portion for automatically ending use of the promotional-shipping-charge data set to establish a shipping charge. The minimum-cart value for shipping promotion need not coincide with any of the price ranges in the shipping-charge data set.

Table 2 below illustrates the “free shipping” selection of FIG. 3 for the 5-7 business days shipping option on orders with a minimum shopping-cart value of $500 being applied to the shipping-charge data set illustrated in Table 1. Table 2 does not illustrate application of the other promos of FIG. 3 to Table 1. When the price of an order, i.e., the total price of all the items in the shopping cart, exceeds $500, the 5-7 business day shipping option is free and a shipping charges of zero dollars will be established.

TABLE 2

| | | Two | Next | Saturday | Saturday |
|---|---|---|---|---|---|
| Your | 5-7 Business | Business | Business | (Order On | (Order on |
| Merchandise Total | Days | Days | Morning | Thursday) | Friday) |
| less than $75.00 | $4.99 | $9.99 | $14.99 | $14.99 | $19.99 |
| $75.01-$150.00 | $7.99 | $12.99 | $17.99 | $17.99 | $22.99 |
| $150.01-$250.00 | $9.99 | $14.99 | $19.99 | $19.99 | $24.99 |
| $250.01-$500.00 | $0.00 | $19.99 | $24.99 | $24.99 | $29.99 |
| $500.01-$1,000.00 | $0.00 | $39.99 | $49.99 | $44.99 | $59.99 |
| $1,000.01-$1,500.00 | $0.00 | $59.99 | $69.99 | $64.99 | $79.99 |
| $1,500.01-$2,500.00 | $0.00 | $69.99 | $79.99 | $74.99 | $89.99 |
| $2,500.01-$4,000.00 | $0.00 | $79.99 | $89.99 | $84.99 | $99.99 |
| more than $4,000.01 | $0.00 | $89.99 | $99.99 | $94.99 | $109.99 |

When the “submit” button of web-based interface 400 is clicked on, the tool 212 receives the promotional-shipping-charge data set created in web-based interface 400 by a user of the administrator client 250. The tool 212 verifies the promotional-shipping-charge data set by checking for errors such as missing ranges, overlapping ranges, non-numeric values, valid “target on-line date” etc. When all the data elements are correct, then the tool 212 presents a confirmation page to the user, and stores the promotional-shipping-charge data set, preferably in a location assigned for staging promotional-shipping-charge data sets. Otherwise, an error message is provided the user, who then has an opportunity to correct the error.

After the batch job referred to in conjunction with FIG. 2 runs to check whether a staged shipping-charge data set is due to be pushed from staging to the production-shipping-rates database 214, the batch job also checks whether the “target on-line date,” i.e., the start time, of a staged promotional-shipping-charge data set equals the system date. When it does, the tool 212 archives any existing promotional-shipping-charge data set, and causes the staged promotional-shipping-charge data set to be stored in the shipping-rates database 214. This causes the promotional-shipping-charge data set to take precedence over corresponding portions of the existing shipping-charge data set exposed to the server for establishing a shipping charge until the end of the promotion.

The promotional-shipping-charge data set automatically terminates when the shipping-charge data set that it takes precedence over is removed from the production-shipping-charge database. In another embodiment, when the promotional-shipping-charge data set includes a target off-line date, the tool causes the promotional-shipping-charge data set to be moved from the shipping-rates database 214 at the target off-line date, and terminates the promotion.

In an alternative embodiment, the tool 212 allows a plurality of promotional-shipping-charge data sets to be entered in the web-based interface 400 for use by the server in establishing shipping charges in a manner similar to that described for shipping-charge data sets. No overlap in effective dates is allowed by the tool 212.

In yet a further embodiment, the tool 212 provides for a promotional-shipping-charge data set to be selected by a user from a library of possible promotional-shipping-charge data sets in substantially the same manner as a shipping-charge data set may be selected.

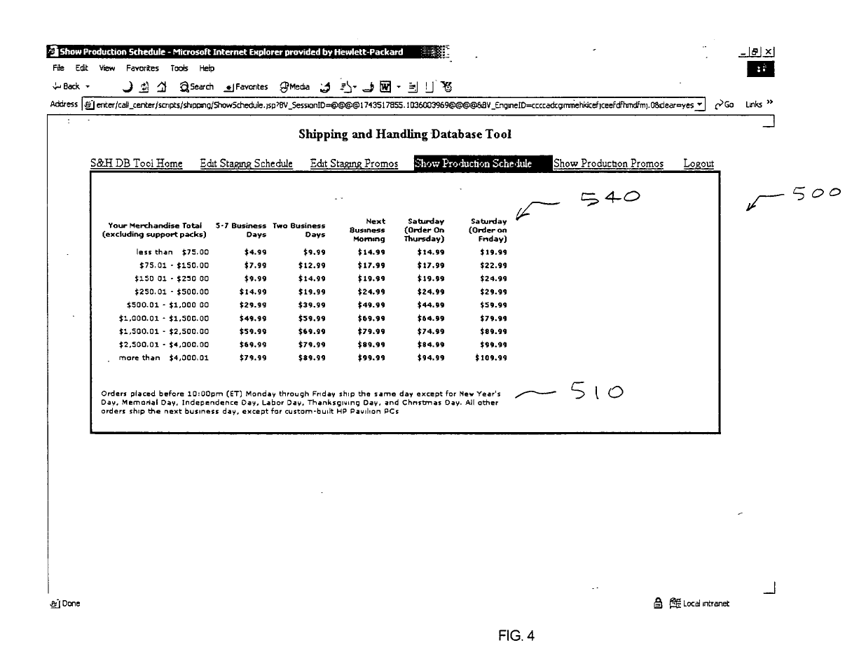

Referring to FIG. 4, and as described in conjunction with FIG. 1, the home page of the shipping administrator tool 212 presents a user with a “show production schedule” option. Selecting the “show production schedule” option presents a user with a web-based page 500 in response. FIG. 4 is a screen print of a web-based page 500 provided by the tool 212 showing the current shipping-charge data set stored in the production-shipping-charge database of the shipping-rates database 214, according to an embodiment of the invention. The web-based page 500 includes information guidelines 510 that may be displayed to a customer, and a matrix 540 of possible order price ranges, shipping options, and a shipping charge for each shipping option for each price range presented in a manner similar to the matrix of FIG. 2.

As also described in conjunction with FIG. I above, the home page of the shipping administrator tool 212 presents a user with a “show production promos” option. Selecting the “show production promos” option presents a user with a web-based page (not shown) showing the current promotional-shipping-charge data set stored in the production-shipping-charge database of the shipping-rates database 214, in accordance with an embodiment of the invention.

The shipping administrator tool 212 includes a series of computer-executable instructions for performing the functions described in conjunction with FIGS. 1-4. The computer-executable instructions may be contained in a computer-readable medium, such as a computer-storage media or a propagated signal.

The shipping administrator tool 212 is extendable, allowing creation and maintenance of other data sets in a database used by a server to establish a price for a product, an item, service, or other commodity (collectively referred to as “item”) that have a plurality of possible prices that are a function of a variable. For example, the shipping administrator tool 212 may be arranged to create and maintain a room-pricing and promotion data set for a hotel. The interface 300 of FIG. 2 may be arranged such that the matrix 340 is organized with a plurality of seasons intersecting with a plurality of room types. For example, the top row 342 could list seasons and their dates, such as summer, fall, holiday, winter, and spring seasons. A left hand column could list room types, such as studio, one-bedroom, one-bedroom plus sleeper couch, two-bedroom, and three-bedroom. The user would enter the room prices for each season into the matrix 342 of the tool 212, and a target on-line date. The tool would then receive the room-price data set, verify the entries, and at the target on-line date, store the room-price data set in a location exposed to a server such that the server can establish a room charge for a reservation in response to a room and a date selection. By way of further example, the tool 212 may be arranged to create and maintain an airline ticket pricing and promotion data set.

The various embodiments of the invention may be implemented as a sequence of computer-implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special-purpose digital logic, or any combination thereof without deviating from the spirit or scope of the present invention.

What is claimed is:

1. A method of creating a shipping-charge data base comprising the steps of:
receiving a first shipping-charge data set that includes a plurality of possible order price ranges, at least one shipping option for each price range, and a shipping charge for each shipping option; and
storing the first shipping-charge data set at a location exposed to a server such that the server can establish a shipping charge for an order in response to a price of the order and a shipping-option selection for the order.

2. The method of claim 1, including the further step of storing a first start time for the server to begin using the first shipping-charge data set to establish the shipping charge.

3. The method of claim 1, including the further step of verifying that the possible order price ranges do not overlap.

4. The method of claim 1, including the further steps of:
receiving a second shipping-charge data set that also includes a second start time for the server to begin using the second shipping-charge data set to establish a shipping charge;
storing the second shipping-charge data set; and
at the start time, causing the second shipping-charge data set to be stored at the location exposed to the server.

5. The method of claim 1, wherein the location is a production-shipping-charge database, and further including the further steps of:
receiving a second shipping-charge data set that also includes a second start time for the server to begin using the second shipping-charge data set to establish a shipping charge;
storing the second shipping-charge data set; and
at the second start time, pushing the second shipping-charge data set into the production-shipping-charge database for use by the server for establishing a shipping charge.

6. The method of claim 1, including the further steps of:
receiving a promotional-shipping-charge data set that includes at least one promotion shipping option and a period of time for the promotional-shipping-charge data set to be in effect;
storing the promotional-shipping-charge data set; and
during the period of time, causing the promotional-shipping-charge data set to take precedence over corresponding portions of the shipping-charge data set that is exposed to the server for establishing a shipping charge for an order in response to a price of an order and a shipping-option selection.

7. The method of claim 6, including the further step of, at the end of the period of time, deactivating the promotional-shipping-charge data set such that it no longer takes precedence over the shipping-charge data set.

8. A computer-readable medium having computer-executable instructions for performing the steps recited in claim 1.

9. A method of creating a promotional-shipping-charge data set comprising the steps of:
receiving a promotional-shipping-charge data set that includes at least one promotion shipping option and a period of time for the promotional-shipping-charge data set to be in effect;
storing the promotional-shipping-charge data set; and
during the period of time, causing the promotional-shipping-charge data set to go into effect and take precedence over corresponding portions of a shipping-charge data set that is exposed to the server for establishing a shipping charge for an order in response to a price of the order and a shipping-option selection, the shipping-charge data set including a plurality of possible order price ranges, at least one shipping option for each price range, and a shipping charge for each shipping option.

10. The method of claim 9, wherein at least one promotion includes free shipping.

11. The method of claim 9, wherein the promotion includes an upgrade to another shipping option when the shipping-charge data set includes multiple shipping options.

12. The method of claim 9, including the further step of, at the end of the period of time, deactivating the promotional-shipping-charge data set such that it no longer takes precedence over the shipping-charge data set.

13. A computer-readable medium having computer-executable instructions for performing the steps recited in claim 9.

14. A computer-implemented method comprising the steps of:
storing a shipping-charge data set that includes a plurality of possible order price ranges, at least one shipping option for each price range, and a shipping charge for each shipping option;
receiving a shipping-option selection for an order; and
establishing a shipping charge for the order from the shipping-charge data set in response to the price of the order and the shipping-option selection.

15. The method of claim 14, wherein the storing step further includes storing a start time to begin using the shipping-charge data set to establish the shipping charge; and further including the further step of, after the start time, causing the shipping-charge data set to be used to establish the shipping charge.

16. The method of claim 14, including the further steps of:
storing another shipping-charge data set, including a start time to begin using the another shipping-charge data set to establish a shipping charge; and
at the start time, using the another shipping-charge data set to establish the shipping charge.

17. The method of claim 14, wherein the location is a production-shipping-charge database, and further including the further steps of:
receiving a second shipping-charge data set that also includes a second start time for the server to begin using the second shipping-charge data set to establish a shipping charge;
storing the second shipping-charge data set; and
at the start time, pushing the second shipping-charge data set into the production-shipping-charge database and using the another shipping-charge data set to establish the shipping charge.

18. The method of claim 17, including the further step of, at the start time, pushing the shipping-charge data set into a shipping charge history database.

19. The method of claim 14, including the further steps of;
receiving a promotional-shipping-charge data set that includes at least one promotion shipping option and a period of time for the promotional-shipping-charge data set to be in effect;
storing the promotional-shipping-charge data set; and
during the period of time, causing the promotional-shipping-charge data set to take precedence over corresponding portions of the shipping-charge data set in the production-shipping-charge data base and used for establishing the shipping charge.

20. A computer-readable medium having computer-executable instructions for performing the steps recited in claim 14.

21. A method of generating a shipping-charge database in a web server, comprising the steps of:
receiving a first shipping-charge data set into a shipping-charge administration tool from an administrator client having a web-based interface, the data set including a plurality of possible order price ranges, at least one shipping option for each price range, and a shipping charge for each shipping option;
using the administration tool to store the data set in a data base at a location exposed to the server for use in establishing a shipping charge for an on-line order in response to a price of the order and a shipping-option selection for the order.

22. The method of claim 21, wherein the shipping-charge data set further includes a start time for using the shipping-charge data set to establish the shipping charge.

23. The method of claim 21, wherein the location is a production-shipping-charge database, and further including the further steps of:
receiving a second shipping-charge data set that also includes a second start time for the web-server to begin using the second shipping-charge data set to establish a shipping charge;
storing the second shipping-charge data set; and
at the second start time, pushing the second shipping-charge data set into the production-shipping-charge database for use by the web-server for establishing a shipping charge.

24. The method of claim 21, including the further steps of:
receiving a promotional-shipping-charge data set that includes at least one promotion shipping option and a period of time for the promotional-shipping-charge data set to be in effect;
storing the promotional-shipping-charge data set; and
during the period of time, causing the promotional-shipping-charge data set to take precedence over corresponding portions of the shipping-charge data set that are exposed to the web-server for establishing a shipping charge.

25. A computer-readable medium having computer-executable instructions for performing the steps recited in claim 21.

26. A computer-implemented system configured for establishing a shipping charge for an order having a price, the system comprising:
at least one server having at least one processor;
at least one database storage device exposed to the server;
a plurality of processes spawned by the at least one processor, the processes including:
(i) accessing a stored shipping-charge data set, the data set including a plurality of possible price ranges for the order, at least one shipping option for each price range, and a shipping charge for each shipping option;
(ii) receiving the order and a shipping-option selection for the order; and
(iii) establishing the shipping charge for the order from the shipping-charge data set in response to the price of the order and the shipping-option selection.

27. The system of claim 26, wherein the method is performed on a server that receives orders from a customer client connected to a computer network.

28. The system of claim 27, wherein the server functions as a component of a web site and the computer network is the Internet.

29. The system of claim 26, wherein the processes further include:
(iv) receiving another shipping-charge data set that also includes a start time for using the another shipping-charge data set to establish a shipping charge;
(v) storing the shipping-charge data set in a production-shipping-charge database;
(vi) storing the another shipping-charge data set; and
at the start time, pushing the another shipping-charge data set into the production-shipping-charge database for use by the server for establishing a shipping charge.

30. A method of creating a pricing data base comprising the steps of:
receiving from an application a first pricing data set that includes a plurality of items, at least one item having a plurality of possible prices that are a function of a variable, at least two variables for one item, and a price for each variable; and
storing the first pricing data set at a location exposed to a server such that the server can establish a price for an item in response to a selection of the item and a selection of a variable.

31. The method of claim 30, including the further step of storing a first start time for the server to begin using the first pricing data set to establish a price for the item.

32. The method of claim 30, including the further steps of:
receiving a second pricing data set that also includes a second start time for the server to begin using the second pricing data set to establish a price for the item;
storing the second price data set; and
at the start time, causing the second pricing data set to be stored at the location exposed to the server.

33. The method of claim 30, wherein the location is a production pricing database, and further including the further steps of:
receiving a second pricing data set that also includes a second start time for the server to begin using the second pricing data set to establish a price for the item;
storing the second price data set; and
at the second start time, pushing the second price data set into the production-pricing database for use by the server for establishing a price for the item.

34. The method of claim 30, including the further steps of:
receiving a promotional-pricing data set that includes at least one promotion pricing option and a period of time for the promotional price data set to be in effect;
storing the promotional-pricing data set; and
during the period of time, causing the promotional-pricing data set to take precedence over corresponding portions of the price data set that is exposed to the server for establishing a price for an item.

35. The method of claim 30, including the further step of, at the end of the period of time, deactivating the promotional-price data set such that it no longer takes precedence over the pricing data set.

36. A computer-readable medium having computer-executable instructions for performing the steps recited in claim 30.
